(19) United States
(12) Patent Application Publication
(10) Pub. No.: US 2014/0282746 A1
(43) Pub. Date: Sep. 18, 2014

(54) METHOD AND SYSTEM FOR MANAGING CHANNEL INDEXED CONTENT AND ELECTRONIC DEVICE IMPLEMENTED WITH SAID SYSTEM

(71) Applicant: miiiCasa Taiwan Inc., Taipei City (TW)

(72) Inventors: CHIH-CHIANG LIN, Taipei (TW); YU-HSIANG WANG, Taipei (TW); CHENG-TING CHENG, Taipei (TW)

(73) Assignee: miiiCasa Taiwan Inc., Taipei City (TW)

(21) Appl. No.: 14/192,886

(22) Filed: Feb. 28, 2014

Related U.S. Application Data
(60) Provisional application No. 61/798,181, filed on Mar. 15, 2013.

(51) Int. Cl. H04N 21/482

(52) U.S. Cl. CPC H04N 21/482
USPC 725/61

(57) ABSTRACT

The present disclosure provides a user interface, a method, a system and an electronic device for providing channel indexed contents as an over-the-top (OTT) service. The user interface, the method and the system may be implemented on electronic devices to provide a “channel mode” other than the default operation modes of the electronic devices. In channel mode, content are selected by inputting a channel index value using a remote controller or a smart phone, and the electronic device then retrieves the content according to the content address corresponding to the channel index value. More specifically, the electronic device switches from its default operation mode to the channel mode when the electronic device is connected to an external display, such as a television. Therefore, the electronic device may provide a large-screen experience for OTT services with a large-screen device as an external display.

### 1. FIELD

The present invention relates generally to a method and a system for providing contents in television (TV) and internet service field, especially for over-the-top (OTT) services. The method may be used on any electronic device that has storage for contents and communication means for output contents and for input commands. More specifically, the present invention relates to a method and a system for a electronic device to switch its user interface and for providing OTT services through the electronic device.

### 2. BACKGROUND

In recent years, internet services are prevailing over many application fields and changing user's behavior for accessing contents including photo, music, video, multimedia streaming data, application program, web services or any specific formatted documents. An emerging type of service is over-the-top service (OTT) which is generally not offered by the network operator. Content or services are provided without requirement of business or technology affiliations with network operators. It provides user broaden choices for accessing more and more contents or services. In addition, OTT services may be provided over various networks, such as the internet, communication networks or TV broadcasting networks, and on various devices, such as smart phone, tablet computers, desktop computers or other devices with network access. Recently, OTT services on televisions or similar devices are emerging due to the visual-comfort nature of devices with large screen size and home-sharing nature of living room devices. The term “large screen size” is only for describing the screen sizes that may be larger than the average screen sizes of portable electronic devices.

However, a user generally needs a dedicated device, such as a set-top box, television streaming player and media player, for utilizing OTT services on television or other similar device in current technology. Otherwise, a user may need a smart TV with built-in OTT services. The requirement of extra hardware implementation devices for OTT services causes extra cost and inconvenience for utilizing OTT services on devices with large screen size for sharing contents between people at a specific place.

In addition, electronic devices such as smart phones, tablet computers, electronic book readers and smart digital cameras have different content sources and navigation behaviors from televisions. For example, electronic devices such as smart phones or tablet computers use desktop-like graphic user interfaces on a touch screen for short range interaction with users. Contents or services are defined as applications (app) for touch-screen-intuitive navigation behavior. However, a television use as few as graphic user interface components to provide a maximum view of content and use a remote controller for interaction in more distant range. Contents or services are indexed as channels for simplifying the design for the remote controllers of television. The terms “short range” and “distant range” are only a comparison for the illustrating the distance from the user's eyeballs to where the content in the device presented on. The different navigation behavior also limits the integration or switch between electronic devices and external devices with large screen size.

According to the above, what is needed is a method or a system using such method for resolve the issue of the extra hardware implementation for utilizing OTT services on large-screen devices and the issue of the different navigation behavior for contents or services between portable devices and large-screen devices. Therefore, the electronic devices may provide a large-screen experience for OTT services with a large-screen device as an external display. In other words, the existing electronic devices may be a new source for OTT services on television with channel-indexed contents for TV-liked navigation behavior and distant range interaction with users. As a result, an additional OTT service choice on large-screen device with no extra hardware implementation costs may be provided.

### BRIEF SUMMARY OF THE INVENTION

The invention provides a method for switching content management user interface of electronic device from its default configuration to a new configuration with contents indexed as channels for television-like navigation and interaction experience. That is, the invention provides a “channel mode” for a electronic device instead of the “default mode” of the electronic device while the electronic devices connected to an external display. In channel mode, each of contents is indexed by a channel index such as a channel number or any direct index code, and the user may retrieve contents, or switch channels, namely, by entering the channel index to the electronic device. The channel mode may further enable the electronic device to receive user inputs from a remote controller for a distant range interaction with the user. The method includes the steps of detecting whether the electronic device is connected to an external display and switching content index mechanism of the electronic device from default mode to channel mode. As a result, the user may retrieve contents by directly entering a channel index through a remote controller once the electronic device connected to the external display.

The invention also provides a content management system and a electronic device implemented with said system for managing channel indexed content, or providing said channel mode, namely. The system of present invention also provides a switching mechanism between default mode and channel mode. Once the electronic device connected to an external device, the system may receive a notification message from the operating system of the electronic device and switch to the channel mode from the default mode. The system may further comprise a system manager performing the method of the present invention to replace the default content manager in channel mode. Once said content management system switches to the channel mode, the system manager stops the default content manager and start receiving channel indexes from the user. The system manager may find consent address corresponding to the received channel indexes and retrieve corresponding contents or perform corresponding services. Therefore, the system of the present invention may enable a electronic device to provide channel indexed contents on an external display to provide a television-like navigation and interaction user experience. As a result, the electronic device implemented with the system of the present invention may become an OTT source providing contents or services with television-like navigation and interaction user experience.

Despite of electronic device, the method for switching content management user interface and the content management system of present invention may also be implemented to any existing devices with content access. Any device with content access implemented with the content management system of the present invention may turn into a source of OTT services while connecting to an external display with channel-indexed contents for TV-liked navigation behavior and distant range interaction with users without extra costs.

It should be understood, however, that this summary may not contain all aspects and embodiments of the present invention, that this summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIGS. 1A and 1B are schematic illustration of the electronic device according to one embodiment of the present invention;

FIGS. 1C and 1D are block diagram of the electronic device according to one embodiment of the present invention;

FIG. 2 is a block diagram of the content management system according to one embodiment of the present invention;

FIG. 3 is a block diagram of the system manager of the content management system according to one embodiment of the present invention;

FIG. 4 is a block diagram of the system manager and the content management system according to one embodiment of the present invention;

FIGS. 5A to 5C are flowcharts of the method for switching to channel mode, switching channel and switching to default mode according to one embodiment of the present invention.

FIGS. 6A and 6B are schematic illustration of the change of layout and user interface in default mode and channel mode of the content management system according to one embodiment of the present invention.

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The description will be made as to the embodiments of the present invention in conjunction with the accompanying drawings in FIGS. 1A to 6B. Reference will be made to the drawing figures to describe the present invention in detail, wherein depicted elements are not necessarily shown to scale and wherein like or similar elements are designated by same or similar reference numeral through the several views and same or similar terminology.

FIGS. 1A and 1B illustrate the portable electronic according to one embodiment of the present invention.

Referring to FIG. 1A, the electronic device 100 includes its default user interface and corresponding input mechanism, such as a desktop-like graphic user interface (GUI) with a touch screen as illustrated in FIG. 1A. Users can retrieve contents in the electronic device 100 by operating its default desktop-like graphic user interface through the touch screen of the electronic device 100.

Referring to FIG. 1B, the electronic device 100 is capable to connect to an external display 200 and output its content for displaying on the external display 200. As illustrated in FIG. 1B, the electronic device 100 outputs its content with another user interface and corresponding input mechanism, such as a TV-like user interface with an external input device 300.

In addition, the operating method of retrieving and displaying content may also change after the electronic device 100 connects to the external display. For example, the electronic device 100 may be a tablet computer. While the tablet computer 100 is disconnected to the external display 200, the user may retrieve contents such as activating an application by the selecting an icon on the touch screen. Once the tablet computer 100 connected to the external display 200, the user may retrieve contents by inputting a channel number through the remote controller 300. The tablet computer 100 may be configured to receive channel numbers from the remote controller 300 through wireless data transmission, such as infrared, Bluetooth and Wi-Fi transmission.

In one embodiment of the present invention, the content displayed on the external display device 200 may be displayed in a layout different from the layout in which the content being displayed on the portable device 100. For example, while the content displayed on the external display device 200 may be in a layout with no touch-intuitive or mouse-applicable graphic user interface, such as a right-sided scroll bar and a selectable button. Instead, the content may be resized to fit into the screen pixel size of the external display 200 and be displayed with a hot key hint icon corresponding to the external input device 300.

FIGS. 1C and 1D illustrate the embodiments of the portable electronic according 100 according to the present invention.

Referring to FIG. 1C, the electronic device 100 may include a processor 110, a memory 120, a storage module 130 for storing contents, a default input module 140 for receiving user inputs while the electronic device disconnected to the external display 200, an output interface module 150 for connecting the portable device 100 to the external display 200, and an external input interface for receiving user inputs from the external input device 300 while the electronic device 100 connected to the external display 200.

Referring to FIG. 1D, in another embodiment of the present invention, the electronic device 100 may include a processor 110, a memory 120, a storage module 130 for storing contents, a default input module 140 for receiving user inputs while the electronic device disconnected to the external display 200 and a communication module 170 for transmitting content to the external display 200 and receiving user inputs from the external input device 300 while the electronic device 100 connected to the external display 200.

The electronic device 100 of the present invention may be a smart phone, a tablet computer, a personal digital assistant (PDA), a laptop computer, an electronic book reader, a digital photo frame, a digital camera, a video recorder, an audio player, a media player, a game console, a signal amplifier device, projector, a router, a wireless access point, a set-top box, a pico base station, femtocell or any wearable devices. In addition The electronic device 100 of the present invention may also be any device having output interface module 150 for displaying content on the connected external display 200, wherein the output interface module 150 may be any video or audio interface for transferring data which can be implemented adopting customized protocols or following existing standards or de facto standards such as High-Definition Multimedia Interface (HDMI), Video Graphics Array (VGA), DisplayPort, Thunderbolt, Lightning Bolt, Universal Serial Bus (USB), Micro Universal Serial Bus (Micro USB) or Mobile High-Definition Link (MHL). The output interface module 150 may be further including a customized connector or a standard connector such as HDMI connector, VGA connector, DisplayPort connector, Mini DisplayPort (MDP) connector, USB connector, Micro USB connector, Thunderbolt connector, Lightning connector or MHL connector. However, the output interface module 150 may also be implemented as a wireless chip adopting customized protocols or following existing wireless standards or de facto standards such as IEEE 802.11 series (Wireless Local Area Network, WLAN) including Wi-Fi series or Wireless Gigabit Alliance (WiGig) Standard, IEEE 802.11 series including Bluetooth®, Miracast, Digital Living Network Alliance (DLNA) Standard, Wireless Home Digital Interface (WHDI), WirelssHD standard, Wireless USB, WiDi developed by Intel®, Allshare developed by Samsung® or Airplay developed by Apple®. Moreover, the electronic device 100 of the present invention may also be any device having communication module 170 for transferring data to the external display 200 and receiving data from the external input device 300, wherein the communication module 170 may be adopting customized protocols or following existing standards or de facto standards such as Ethernet, IEEE 802.11 or IEEE 802.15 series, Wireless USB or telecommunication standards such as GSM, CDMA2000, TD-SCDMA, WiMAX, 3GPP-LTE or TD-LTE.

Despite of electronic device 100, the invention may also be applied to any existing devices with capability to access content, such as smart appliances at home. However, the electronic device 100 of present invention may provide the user to access contents in the electronic device 100 at any place with the external display 200. Hence, portable electronic device may be a more recommended implementation of the present invention in view of the regional limitations.

The external display 200 of the present invention may be any devices with an interface for receiving content data and a display means for displaying contents, such as an external monitor for computing device, a television or a projecting device.

The processor 110 of the present invention may be a processor or a controller for executing the program instruction in the memory 120 which may be SRAM, DRAM, EPROM, EEPROM, flash memory or other types of computer memory. The processor 110 may further include an embedded system or an application specific integrated circuit (ASIC) having embedded program instructions.

The storage module 130 of the present invention may be a non-volatile computer readable recording medium embedded in the electronic device 100 including ROM, RAM, EPROM, EEPROM, hard disk, solid state drive, soft disk, CD-ROM, DVD-ROM or other forms of electronic, electromagnetic or optical recording medium. In one embodiment of the present invention, such storage module 130 may include interfaces that can access the aforementioned computer readable recording medium to enable the electronic device 100 to connect and access such computer readable recording medium. In another embodiment of the present invention, the storage module 130 may include network accessing device to enable the electronic device 100 to connect and access the contents in a remote server or a network-attached storage.

The default input module 140 of the present invention is embedded into the electronic device 100. The default input module 140 may be a control panel, a touch-sensing device, an embedded keypad, an image capturing device, a voice receiving device or other sensing devices. The aforementioned input device may receive and retrieve user input control signal, touch sensing signal, image signal, voice signal or other sensing signal, and transform them into control information. However, in some embodiments of the present invention, the electronic device 100 may not include the default input module 140. That is, in default mode of the electronic device 100, a user cannot input any command to retrieve any specific contents and the contents may be retrieved in a preconfigured manner.

The external input module 160 of the present invention includes an input interface, which may include a radio frequency receiver or a physical interface. The radio frequency receiver may be used to receive the radio signal from an external input device 300 with a radio frequency transmitter. The received radio signal may be transformed into user input by the electronic device 100. The physical interface may be compatible with a wired input device as the external input device 300, such as a keyboard, a touch-sensing device, an image capturing device, a voice receiving device or a brain wave receiving device. The aforementioned input device may receive and retrieve user input control signal, touch sensing signal, image signal, voice signal or brain wave signal, and transform them into control information, touch sensing information, voice information or brain wave information to be inputted into the electronic device 100 through the external input module 160.

FIG. 2 illustrates the content management system implemented in the electronic device 100 according to one embodiment of the present invention.

The content management system may operate in two modes including default mode and channel mode. In default mode, contents in the electronic device 100 may be retrieved and displayed in a preconfigured way, and user may operate the electronic device 100 through a preconfigured user interface. However, in channel mode, each of the contents in the electronic device 100 may be indexed by a channel index and retrieved while receiving the corresponding channel index. In addition, the content management system in channel mode may allow the electronic device 100 for recognizing the commands received from the external input device 300, such as a remote controller.

For example, in one embodiment of the present invention, the electronic device 100 may be a digital still camera with an embedded display and a control panel beside the embedded display. The control panel may comprise a “next button” and a “previous button” for user to pickup photos to display on the embedded display as the preconfigured setting, or the default mode of the content management system namely, of the electronic device 100. The electronic device 100 may further comprise an output interface for connecting to the external display and a wireless communication module for communicating to a remote controller through wireless local area network (WLAN). While the electronic device 100 connecting to the external display 200, the content management system may switch its operation into the channel mode. The user may enter a channel index such as through the external input device 300 into the electronic device 100 for displaying corresponding photo on the external display 200.

Referring to FIG. 2, the content management system includes a system manager 410, a default content management manager 420, a channel database 430 storing channel index and content address, a content database 440 storing content data, a layout controller 450 for matching content to layout templates for display and a layout template list 460 storing the layout templates, a channel mode content manager 470. Once the electronic device 100 connected to the external display 200, a notification message will be broadcasted by the operating system of the electronic device 100, and the system manager 410 would receive the notification message and switch to the channel mode. In channel mode, the system manager 410 may recognize the input command received from the external display device. While the input command containing a channel index, the system manager 410 may search the content address corresponding to the channel index in the channel database 430. The channel mode content manager 470 may retrieve the content data corresponding to the channel index from the content database 440 and request the layout controller 450 to read the layout template corresponding to the content in channel mode from the layout template list 460.

The layout templates may be categorized by the pixel resolutions, location settings or types of contents. The system manager 410 may further receive pixel resolution information and location setting of the external display 200 in the notification message from the operating system, and the channel mode content manager 470 and the layout controller 450 may further cooperate to read out the layout templates corresponding to the pixel resolution information and location setting from the layout template list 460.

The channel database 430 in the present invention stores content addresses of the contents in the electronic device 100 and channel indexes corresponding to the content addresses. The content address may include web address of webpage, wired or wireless television channel, data path of locally stored file or application, and the virtual channel numbers that may map to the aforementioned web address of webpage, wired or wireless television channel, or data path of locally stored file or application. The channel index may be any type of string, and may include combinations of Arabic numerals, English characters and specific characters. Each channel index may match to one content address in the channel database 430 for the system manager 410 to retrieve the content address in the channel database 430.

The content database 440 stores content data and the content data may be updated while the content being retrieved with a running program. The contents of the present invention may include video files, image files, audio files, documents, application programs, web pages, streaming data or streaming services which may be stored in the storage module 130 of the present invention. However, the content database may store an address of contents in other content sources so that other contents from said content sources may be provided by the content management system. The content sources may include not only the storage module 130 but additional external storage devices, the internet, content management websites and radio broadcasting systems. The default content manager 420 or the channel mode content manager 470 of the present invention may open the file or the application according to the data path of the file or the application in the storage module 130 or other external storage devices. The Internet 420 may include webpage or other contents of a website which may also be retrieved by default content manager 420 or the channel mode content manager 470 of the present invention. The content management website 430 may be applications store, streaming video or music provider, video or music downloading website, electronic book provider (such as App Store, Google Play, Netflix, YouTube, iTunes store or Amazon Kindle). The default content manager 420 or the channel mode content manager 470 of the present invention may retrieve the login page according to the content address and provide corresponding user name and password for login. After the content download or streaming service provider's webpage is retrieved, the user may download the content or receive streaming service. The radio broadcast system may include wireless and wired television channels as contents in the present invention.

The channel database 430 and the content database 440 of the present invention may be integrated as only one database. That is, the content database 440 may also store the content address and the corresponding channel index for each of the contents in content database 400 instead of a separate channel database 430 in the content management system of the present invention. Moreover, the channel database 430 and the content database 440 of the present invention may be implemented as a specific-formatted file such as an XML file respectively instead of in the form of a database.

Moreover, the channel database 430 and/or the content database 440 may be shared by a plurality of devices implemented with the content management system of the present invention. In one embodiment of the present invention, each user of the content management system of the present invention may have an account respectively. Each account may share a channel database and/or a content database on a remote server. Data in the channel database 430 and/or the content database 440 may be synchronized with the channel database and/or the content database on the remote server. The mechanism of the aforementioned user account may allow multiple devices to share the same data in each device implemented with the content management system of the present invention. However, in another embodiment of the present invention, each device implemented with the content management system of the present invention may have an account managed by a remote server respectively. Each device may have its own channel database 430 and/or the content database 440. The mechanism of the aforementioned device account may allow each device to provide customized OTT service with its own channel and/or content data.

On the other hand, once the electronic device 100 disconnected from the external display 200, another notification will be broadcasted by the operating system of the electronic device 100, and the system manager 410 would receive the notification message and switch to the default mode. In default mode, the system manager 410 will not interfere with the operation of the default content manager 420. The default content manager 420 may retrieve contents corresponding to the user input through the default input module 140 and request the layout controller 450 to read the layout template corresponding to the content in default mode from the layout template list 460.

FIG. 3 further illustrates the system manager 410 of content management system according to one embodiment of the present invention.

Referring to FIG. 3, the system manager 410 may comprise an input component 411, a mode switch component 412, a database management component 413 and a channel switch component 414. The input component 411 may receive notification message of input events from the operating system of the electronic device 100. The notification messages are often broadcasted from the operating system to each running program including the system manager 410. Particularly, once the personal electric device 100 connected or disconnected to the external device 200, the operating system may broadcast a corresponding notification message. The system manager 410 may receive and recognize the message and request the mode switch component 412 to switch the operation of the content management system between default mode and channel mode. The mode switch component 412 may temporarily stop the current running content manager including the default content manager 420 or the channel mode content manager 470 and activate the other content manager. The mode switch component 412 may further record the status and setting of the paused content manager and recover the recorded status and setting while switch back.

Referring to FIG. 3 again, the content management system may contain the default content manager 420 only, and the mode switch component 412 may activate or deactivate the channel switch component 414 instead of the channel mode content manager 470.

Once the content management system switched to the channel mode, the input component 411 may recognize the user input from external input device 300 in the notification messages of input events. If a user input contains a channel index and a command for channel switch, the input component 411 may pass the channel index to the database management component 413 to retrieve the corresponding content address in the channel database 430. The database management component 413 may pass the retrieved content address to the channel switch component 414, and the channel switch component 414 may retrieve content data corresponding to the content address. Hence, the channel switched according to the channel index inputted by the user in channel mode. As a result, the system manager 410 may provide a channel-indexed mechanism for retrieving contents as the electronic device 100 connected to the external display 200.

The database management component 413 may further update the channel database while a user may input a command for assigning one of the contents to a specific channel index in channel mode. The database management component 413 may updated the channel database 430 according to the channel index and the content address. Moreover, in one embodiment of the present invention, records of correspondence of channel indexes and contents on a remote server may be downloaded by the database management component 413. The database management component 413 may update the channel database 430 according to said records. In another embodiment of the present invention, records of correspondence of channel indexes and contends may be stored in form of a channel list. Said channel list may be synchronized with a channel database on a remote server by the database management component 413. Therefore, a device implemented with the system manager 410 of the present invention may be able to succeed the channel list of another device. In addition, said remote sever may have an account database for managing said channel lists to share multiple channel lists on multiple devices of a user.

The system manager 410 may further include a user interface component 415. The user interface component 415 may cooperate with the input component 411 to display user interfaces with information corresponding to the user inputs on the displayed screen.

For example, in one embodiment of the present invention, while the electronic device 100 connected to the external display 200 and the content management system switched to the channel mode, the user interface component 415 may output a bar in the upper right corner of the screen and on top of the displayed content with notification information such as “channel mode” or “TV mode”. While the user inputting channel number through the external input device 300, the user interface component 415 may correspondingly output the channel number on said information bar such as “ch 146”. In another embodiment of the present invention, the input component 411 may also recognize a command for changing volume output settings of the electronic device 100 from a user input sent by the external input device 300. While the input component 411 sending a message including said command to the operating system of the electronic device 100, the user interface component 415 may output an icon illustrating the volume change corresponding to the user input on the external display. Therefore, the system manager 410 may provide a more comprehensive way for the content management system to interact with the user in channel mode.

Moreover, the user interface component 415 may cooperate with a remote server to receive and display messages from said remote server and display user interfaces with said messages on the displayed screen. The messages may include notifications of events, such as a live baseball game, a weather-change event, real-time comments of the current displaying content, or an advertisement. Information may be stored on said remote server for pushing said messages to the user interface component 415 for displaying on the displayed screen. In one embodiment of the present invention, messages may be pushed to the user interface component 415 according the current displaying contents. In another embodiment of the present invention, said remote sever may also have an account database for managing preferences and/or related-events of device users, and may push messages to the user interface component 415 according the preferences and preferences and/or related-events of the device user.

FIG. 4 illustrates the system manager 410 and the content management system according to another embodiment of the present invention.

Referring to FIG. 4, the system manager 410 may comprise an input component 411, a mode switch component 412, a database management component 413, a channel switch component 414 and a user interface component as mentioned in previous paragraphs. The content management system may include a system manager 410, a default content management manager 420, a channel database 430, a content database 440, a layout template list 460 and a channel mode content manager 470. The channel mode content manager 470 may comprise a channel manager 471 and a layout controller 472. While content data being retrieved and executed by corresponding application program, the content data may be continuously updated. The default content manager 420 and the channel manager 471 may retrieve content data from the content database 440 and store updated data into the content database 440. The channel manager 471 may further recognize a customized content address especially specific data in a file or an application, such as a specific page in an electronic book, a specific photo in a photo album or a specific music in a playlist. Therefore, specific data may be indexed as a channel in the channel mode.

For example, once the content management system switched from default mode to channel mode, the mode switch component 412 may temporarily stop the default content manager 420 and activate the channel manager 471. While the input component 411 of the system manger 410 receiving a channel index and the database management component 413 retrieving the corresponding content address, the channel switch component 414 may retrieve the content data through the channel manager 471. In particular, the channel switch component 414 may recognize whether the content address is a customized address as mentioned in previous paragraph, and the channel manager 471 may retrieve the content data corresponding to said customized content address.

In addition, the channel manager 471 may further read out and recognize the type of the content from the content database 440, such as an audio file, a video file, an application software, an electronic book, a phone number in contact information or a web page corresponding to a uniform resource locator (URL) as the content address. The channel manager 471 may further cooperate with the layout controller 472 to retrieve the layout template with user interfaces according to the type of the content, such as a multimedia player interface for audio files or a page-turn interface for electronic books. Therefore, a customized user interface for contents in channel mode may be provided.

FIGS. 5A to 5C are flowcharts respectively illustrating the method for switching to channel mode, switching channel and switch to default mode according to one embodiment of the present invention. The method of the present invention may be applied on the electronic device 100 implemented with the content management system.

FIG. 5A illustrates the method for switching from default mode to channel mode according to one embodiment of the present invention, and the method of present invention may perform the following steps. In step S111, the electronic device 100 is connected to the external display 200, and the operating system of the electronic device 100 generates a corresponding notification message. The content management system may receive a notification message of connection to the external display 200 via the input component 411. In step S112, the content management system is switched from the default mode of the portable device 100 to the channel mode, wherein the main difference between the default mode and the channel mode is the content index mechanism. The content is directly indexed by a channel index which can be inputted by the user in channel mode. The electronic device 100 may further output the current running content in a layout corresponding to the pixel resolution and local setting of the external display 200 or output a mirrored the current screen to the external display 200. Therefore, once the external display 200 connected to the electronic device 100, contents in the electronic device 100 may be retrieved by simply input a channel index through the external input device 300.

FIG. 5B illustrates the method for switching contents in channel mode according to one embodiment of the present invention, and the method of present invention may perform the following steps. In step S121, the electronic device 100 receives a channel switch command, and the channel switch command contains a channel index. In channel mode, the input component 411 may recognize the channel index and pass to the database management component 413. In step S122, the database management component 413 retrieve content address corresponding to the channel index in the channel database 430 and pass the channel address to the channel switch component 414. In step S123, the channel switch component 414 retrieve the content corresponding to the content address. In some embodiments, the channel switch component 414 may request the channel manager 471 to retrieve content data from the content database 440. In step S124, the content management system outputs the retrieved in a channel mode layout for displaying on the external display 200. The channel mode layout may be generated from a layout template in the layout template list 460 by the layout controller 450 or the layout controller 472.

FIG. 5C illustrates the method for switching from channel mode to default mode according to one embodiment of the present invention, and the method of present invention may perform the following steps. In step S131, the electronic device 100 is disconnected from the external display 200, and the operating system of the electronic device 100 generates a corresponding notification message. The content management system may receive a notification message of disconnection from the external display 200 via the input component 411. In step S132, the mode switch component 412 may wake up the paused default content manager 420 and stopped the channel mode manager 470 according to the notification message received by the input component 411. Therefore, the content management system is switched from the channel mode to the default mode of the portable device 100.

FIGS. 6A and 6B illustrate the change of layout with the user interface in default mode and channel mode of the content management system according to one embodiment of the present invention. In default mode, a home screen of the default content manager 500 may be displayed on the electronic device 100. While switching to channel mode, a home screen of the channel mode content manager 600 may be provided on the electronic device 100 and the external display instead. The different home screens 500 and 600 may be stored as a layout template in the layout template list 460 of the present invention.

FIG. 6A illustrates the layout with the user interface of the default content manager according to one embodiment of the present invention. Referring to FIG. 6A, the home screen of the default content manager 500 is provided with contents 501-508 and a control bar 510. Each of contents from 501 to 508 is displayed as an icon with standard size on the home screen 500. The control bar 510 may contains user interfaces of commands, such as control of volume. User may select icons to activate contents or input commands through a touch screen, a mouse or other input devices with capability to locate a specific area on the home screen 500 and the select the icon in the area. Hence, a desktop-liked home screen for managing contents may be provided in the default mode for navigation of contents on the electronic device 100.

FIG. 6B illustrates the layout with the user interface of the channel mode content manager according to one embodiment of the present invention. Referring to FIG. 6B, the home screen 600 of the channel mode content manager 600 is provided with contents 601-606. Each of contents from 601 to 606 is displayed as a box with a label of its channel index on the display. Preview of contents may also be displayed in the box of each of the contents, especially for streaming media such as CBS 601. No icons are provided in the layout 600 but hints for inputting channel indexes and corresponding keys through a remote controller with a key pad. The key pad may include Arabic numbers and hot keys such as the arrow keys “→” or “←” for scrolling the bottom row of contents 603-606 or a “home” key and a “today” key for switching between the home screen of the channel mode content manager and a list of the daily recommended contents. In the current specific embodiment, the hint for entering the arrow keys “→” or “←” is provided as the black arrows besides content 603 and content 606, and the hints for entering the “home” or “today” keys are provided in the upper right corner. Hence, a TV-liked home screen for managing contents may be provided in the channel mode for navigation of contents on the external display 200.

In another embodiment of the present invention, the electronic device 100 may have an embedded display with its length larger than its width (denoted as a narrow-and-long display). Contents may be sorted and displayed in the vertical direction of the embedded display in the default mode. However, the external display 200 may have its width larger than its length (denoted as a wide display). Contents may be sorted and displayed in the horizontal direction of the external display 200 in channel mode. Hence, a layout template for displaying contents on the narrow-and-long display and a layout template for displaying contents on the wide display may be stored in the layout template list 460 respectively, and may be retrieved and applied for displaying contents in default mode and channel mode respectively.

The content management system and the electronic device 100 may be utilized in many application scenarios as the embodiments of the present invention. The following descriptions contain only some of said embodiments and are not intended to limit the scope of the present invention.

In some embodiments of the present invention, the system manager 410 with channel database 430 may be downloaded and be installed as an application program on a electronic device 100 such as a smart phone or a tablet computer. The system manager 410 may be set to activate and continue running when the electronic device 100 reboots. The system manager 410 may set mode switch component 412 to default mode after activated. Once the electronic device 100 connected to an external display 200, the system manager 410 may temporarily stop the default content managing program (the default content manager 420) and set the mode switch component 412 from default mode to channel mode. The system manager 410 may start performing the methods for channel switching of the present invention and set the mode switch component 412 from channel mode to default mode once disconnected from the external display 200. The system manager 410 then recovers the default content manager 420. For example, the electronic device 100 may be a tablet computer implemented with Android operating system (OS). The default content managing programs are called launcher in Android OS. The system manager 410 may be configured with authority higher to the launcher when installed. While the electronic device 100 connected to a television, the current screen of the electronic device 100 may be mirrored and displayed on the television. The system manager 410 may stop the launcher and start receiving user inputs sent by a remote controller via wireless local area networks. Hence, a electronic device such as a tablet computer or a smart phone becomes an OTT service provider on a television with the system manager 410 of the present invention.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A user interface for an electronic device facilitating selecting contents of the electronic device, comprising:
an input component that receives a content index value;
a trigger component that activates the input component;
an index component that retrieves content address according to the content index value; and
a display component that retrieves the content according to the content address for displaying.

2. The user interface according to claim 1, wherein trigger component activates the input component when the electronic device is connected to an external display device.

3. The user interface according to claim 1, wherein the display component displays the content in a layout different from default layout of the content.

4. The user interface according to claim 1, wherein the trigger component deactivates the input component when the electronic device is disconnected with the external display device.

5. A method for selecting content implemented on an electronic device with a default mode for selecting content, the method comprising:
activating a channel mode from the default mode, and while in the channel mode:
receiving a channel switch command containing a channel index value;
retrieving a content address corresponding to the channel index value and retrieving the content according to the content address; and
outputting the content for displaying.

6. The method according to claim 5, further comprising: receiving a notification message of connection when the electronic device is connected to an external display device before activating the channel mode from the default mode.

7. The method according to claim 5, wherein the content is displayed as an icon for selection in the default mode.

8. The method according to claim 5, wherein while in the channel mode, the content is displayed in a layout different from the layout in the default mode.

9. The method according to claim 5, further comprising:
receiving a notification message of disconnection when the electronic device is disconnected with the external display; and
activating the default mode from the channel mode.

10. A managing system of an electronic device with a default mode for selecting content, comprising:
a mode switch module for switching from the default mode to a channel mode;
an input module for receiving a channel index value in the channel mode;
a database management module for retrieving a content address in a channel database according to the channel index; and
a channel switch module for retrieving content data from a content database for displaying on the external display according to the content address.

11. The managing system according to claim 10, wherein the input module receives a notification message when the electronic device connected to an external display device and the mode switch module switches to the channel mode according to the notification message.

12. The managing system according to claim 10, wherein the content is displayed as an icon for selection in the default mode.

13. The managing system according to claim 10, further comprising a channel mode content management module for retrieving contents from the content database by the channel index, and wherein the channel switch module requests the channel mode content management module for content data by channel index in the channel mode; and wherein the channel switch module requests a default content management module for content data in the default mode.

14. The managing system according to claim 13, further comprising a layout controller for retrieving a layout template corresponding to the content data in the channel mode, and wherein the channel mode content management module sends the content data in the retrieved layout template to the channel switch module according in response to the request from the channel switch module.

15. The managing system according to claim 10, further comprising:
a user interface module for displaying a user interface containing channel index and information related to the displaying content.

16. The managing system according to claim 15, wherein the user interface module receives pushed an advertisement or electronic program guide information from a remote server and displays the advertisement or the electronic program guide information.

17. The managing system according to claim 10, wherein the database management module downloads contents and the channel indexes from a remote server and updates the channel database.

18. A content management system implemented in an electronic device, comprising:
a default content management module for receiving a user's input for selecting content and retrieving the content in default mode; and
a system manager for switching between the default mode and a channel mode, and wherein in the channel mode, the content is selected and retrieved by a channel index.

19. The content management according to claim 18, wherein the system manager switches to the channel mode according when the electronic device is connected to an external display device.

20. The content management system according to claim 18, wherein the content is displayed as an icon for selection in the default mode.

21. The content management system according to claim 18, further comprising:
a content database storing content data;
a channel database storing the channel indexes and the content addresses;
a channel mode content management module for retrieving a content address according to the channel index from the channel database and the content data according to the content address from the content database in the channel mode; and
a layout controller for retrieving a channel mode layout template for the content data in the channel mode and organizing the content data in the layout template before the content data being displayed.

22. The content management system according to claim 18, wherein the channel mode content management module further retrieves the content data from the internet, a broadcast television system or a local storage device.

23. An electronic device having a default mode and a channel mode for selecting contents, comprising:
a memory;
a storage module coupled to the processor for storing at least one content address;
a default input module for receiving user's input for selecting contents in the default mode;
a channel mode input module for receiving a channel switch command containing a channel index value from an external input device;
a processer coupled to the memory, the storage module, the default input module and the channel mode input module, and the processor being configured to retrieve a content address corresponding to the channel index value from the storage module and retrieve the content data according to the content address.

24. The electronic device according to claim 23, further comprising a projector module for projecting the image of the retrieved content onto a screen.

25. The electronic device according to claim 23, further comprising an output interface module coupled to the processor for outputting the content to an external display device when the electronic device is connected to the external display device via the output interface module, and wherein the processor is configured to operate the electronic device in the channel mode while the electronic device connected to the external display device.

26. The electronic device according to claim 23, wherein the default input module is a touch screen displaying contents as icons for user selection, and the channel mode input module is a communication module for receiving the channel switch command via radio frequency.

27. The electronic device according to claim 26, wherein the electronic device is a mobile phone, a tablet computer, a digital still camera, laptop, a multimedia player or an electronic book reader.

28. The electronic device according to claim 25, wherein the electronic device is a wireless access point, a router, a blue-ray disk player, a set-top box, an signal amplifier device, a sound bar, a pico base station or femtocell.

29. The electronic device according to claim 23, wherein while in the channel mode, the processer is further configured to organize the content data in a layout different from the layout in the default mode.

30. A non-transitory computer readable storage medium having stored therein instructions, which when executed by an electronic device with a default mode for selecting content, cause the electronic device to:
activate a channel mode from the default mode, and while in the channel mode:
receive a channel switch command containing a channel index value;
retrieve a content address corresponding to the channel index value and retrieve the content according to the content address; and
output the content for displaying.

31. The non-transitory computer readable storage medium according to claim 30, wherein the content is displayed as an icon for selection in the default mode.

32. The non-transitory computer readable storage medium according to claim 30, wherein while in the channel mode, the content is displayed in a layout different from the layout in the default mode.

33. The non-transitory computer readable storage medium according to claim 30, wherein the non-transitory computer readable storage medium has further stored therein instructions, the channel mode is activated when the electronic device is connected to an external display device.

34. The non-transitory computer readable storage medium according to claim 33, wherein the non-transitory computer readable storage medium has further stored therein instructions, which when executed by an electronic device, cause the electronic device to activate the default mode from the channel mode when the electronic device is disconnected with the external display device.
